(19) United States
(12) Patent Application Publication
(10) Pub. No.: US 2002/0090944 A1
(43) Pub. Date: Jul. 11, 2002

(54) Virtual single cell with frequency reuse

(76) Inventor: Johnny Shepherd, Hillsborough, NC (US)

Correspondence Address: David E. Bennett, Coats & Bennett, Suite 300, 1400 Crescent Green, Cary, NC, 27511, US

(21) Appl. No.: 09/757,906

(22) Filed: Jan. 10, 2001

(51) Int. Cl. H04B 7/00

(52) U.S. Cl. 455/435; 455/436; 455/442; 455/63; 455/524

(57) ABSTRACT

A wireless communication network and related method for communicating with mobile terminals, including a plurality of spaced radio heads each authorized to use all frequencies in a spectrum, a memory and a controller. The memory stores, for each of the radio heads, an identification of which of the other radio heads unacceptably interfere with the each radio head. The controller controls the frequencies used by the plurality of radio heads whereby a frequency being used by one radio head is denied use to radio heads unacceptably interfering with the one radio head, and controls handoff of a mobile terminal communicating with a first radio head on a first frequency to change to communicate with a second radio head. A soft handoff is performed if none of the radio heads stored in the memory as unacceptably interfering with the second radio head are using the first frequency. A hard handoff is performed if any one of the radio heads stored in the memory as unacceptably interfering with the second radio head is using the first frequency.

### BACKGROUND OF THE INVENTION

The present invention is directed toward wireless communication networks, and more particularly toward efficient frequency use in virtual single cells.

Generally speaking, public cellular telephone systems have two levels: a system level which is a group of integrated cells that overlap to provide ubiquitous wireless (radio frequency or RF) coverage, and a cellular level which is a set of radio frequency carriers providing call supervision and voice communications to mobile terminals operating within a specific geographic coverage area. Generally, every cell has transmitters and receivers operating on specific radio frequencies. Call supervision information is provided at each cell over at least one digital control channel (DCCH). The control channel provides information to the mobile terminal for call origination, termination, page response, and handoffs from one cell to another.

However, the frequencies which may be used in such communications are limited. In areas of high use (i.e., where many mobile terminals are operating), this can result in a conflict between the high usage demand and the limited supply of frequencies. One method which has been used to address this conflict has been to use directional antennas which limit the direction of signal transmission in each cell to smaller coverage areas (e.g., to 120 degree coverage areas rather than a 360 degree omni pattern). With this method, all antennas using a particular frequency can be oriented in the same direction, resulting in greater distances between coverage areas and reduced interference. A second method which has been used has been to reduce the coverage areas of cells (by, e.g., using lower power outputs at the cells, reducing the height of the antenna above the ground, or using RF obstructions). Essentially, this method results in greater numbers of smaller cells, so that frequency reuse in a given area of a system may be proportionately increased without increasing interference. A third method which has been used has been multiplexing, where multiple resources (e.g., multiple cellular telephones) utilize one radio frequency carrier. One type of multiplexing which has been used is Time Division Multiple Access (TDMA) in which different time spaces in a channel are assigned to different resources. For example, the IS-136 TDMA standard utilizes RF carriers which have six time slots.

The drive to maximize capacity given this situation of limited frequency availability has led to in-building applications such as digital wireless office systems (DWOS). Coverage inside buildings allows the use of the above methods to maximize capacity, using low power transmitters having innate RF obstructions such as exterior building walls. Several systems have been used for such in-building applications.

One such system, a distributed antenna system, is essentially a large system with RF splitters, where a single RF input is split into multiple RF transmitters which provide coverage to various locations. While this is spectrally efficient (i.e., the transmitters have no limitations on the use of frequencies in the authorized spectrum) and requires only a single control channel operating throughout the entire in-building coverage area, every RF junction increases noise in the system. The coverage from each RF transmitter is therefore reduced as the noise figure of the system increases, thereby requiring more RF emitters and more splits to the input signal to provide ubiquitous coverage, increasing the amount of infrastructure needed to provide quality coverage and raising the cost of providing that coverage. Further, since a given frequency is radiated from all RF emitters simultaneously when in use (even though a mobile terminal requires coverage from one of the RF emitters), the radio waves are not as well contained in the building.

A second in-building system uses pico cells or very low powered individual cell sites, with each cell acting as an independent individual cell with a coverage area overlapping adjacent cells working as a system. This system uses only one RF emitter for any given transmission to a mobile terminal and any frequency used for that traffic channel can be assigned to any individual pico cell. With this system, a given frequency can be simultaneously reused at another pico cell in the system so long as there is adequate frequency reuse distance within the system. Each such pico cells can be assigned a specific set of frequencies to use, advantageously allowing remote coverage in the system when needed, but disadvantageously requiring each pico cell to be assigned a different control channel due to the use of Mobile Assisted Handoffs (MAHO) (since such handoffs require that the mobile terminal reference the control channel of each pico cell), reducing spectral efficiency and requiring significant administrative work with each pico cell (to set up neighbor lists for handoffs between such cells). Further, since each pico cell essentially functions as an individual cell site, significant costly infrastructure can be required in connection with providing the required intelligence to each cell.

A third in-building wireless communication system is known as a virtual single cell (VSC), which provides spectrally efficient operation. A VSC uses a single digital control channel (DCCH) by all RF emitters (radio heads), and the radio heads can use any traffic frequency from the allowed group (spectrum). A controller for the system eliminates the administrative processes for handoffs between radio heads and thereby reduces infrastructure costs. Splitters are eliminated as is the use of MAHO in call processing. Call processing functions are handled by the network controller and primarily based on uplink measurements, with the controller monitoring all radio heads for each call and re-directing the call to the radio head that can best pick-up the mobile terminal's uplink. Signal handoffs are soft handoffs from one radio head to another, directing the radio frequency signal to two radio heads simultaneously while the mobile terminal moves from one coverage area to another. The VSC also provides spectral efficiency by allowing the same frequency to be used in different time slots at different radio heads for two different mobile terminals at any given time. The present invention provides still further improvements upon such systems.

### SUMMARY OF THE INVENTION

In one aspect of the invention, a virtual single cell wireless communication network is provided for communicating with mobile terminals, including a plurality of spaced radio heads each authorized to use all frequencies in a spectrum, a memory and a controller. The memory stores, for each of the radio heads, an identification of which of the other radio heads unacceptably interfere with the each radio head. The controller controls the frequencies used by the plurality of radio heads whereby a frequency being used by one radio head is denied use to radio heads unacceptably interfering with the one radio head, and controls handoff of a mobile terminal communicating with a first radio head on a first frequency to change to communicate with a second radio head. A soft handoff is performed if none of the radio heads stored in the memory as unacceptably interfering with the second radio head are using the first frequency. A hard handoff is performed if any one of the radio heads stored in the memory as unacceptably interfering with the second radio head is using the first frequency.

In another aspect of the invention, a method of handing off communication in a virtual single cell wireless communication network is provided, including authorizing all of the radio heads to selectively use all frequencies in a spectrum, determining which of the radio heads will unacceptably interfere with each radio head, and handing off a mobile terminal communicating on a first frequency with one radio head when the mobile terminal moves to the coverage area of another radio head by performing a soft handoff if none of the radio heads determined to unacceptably interfere with the other radio head are using the first frequency and performing a hard handoff if any one of the radio heads determined to have unacceptable interference with the other radio head is using the first frequency.

### BRIEF DESCRIPTION OF THE DRAWINGS

FIG. 1 is a block diagram of a mobile terminal;

FIG. 2 is a block diagram of a VSC wireless communication network;

FIGS. 3-4 are a flow chart for determining Minimum Reuse Distance according to the present invention; and

FIGS. 5-7 illustrate the operation of the communication network of FIG. 2 as a mobile terminal moves through its coverage area.

### DETAILED DESCRIPTION OF THE INVENTION

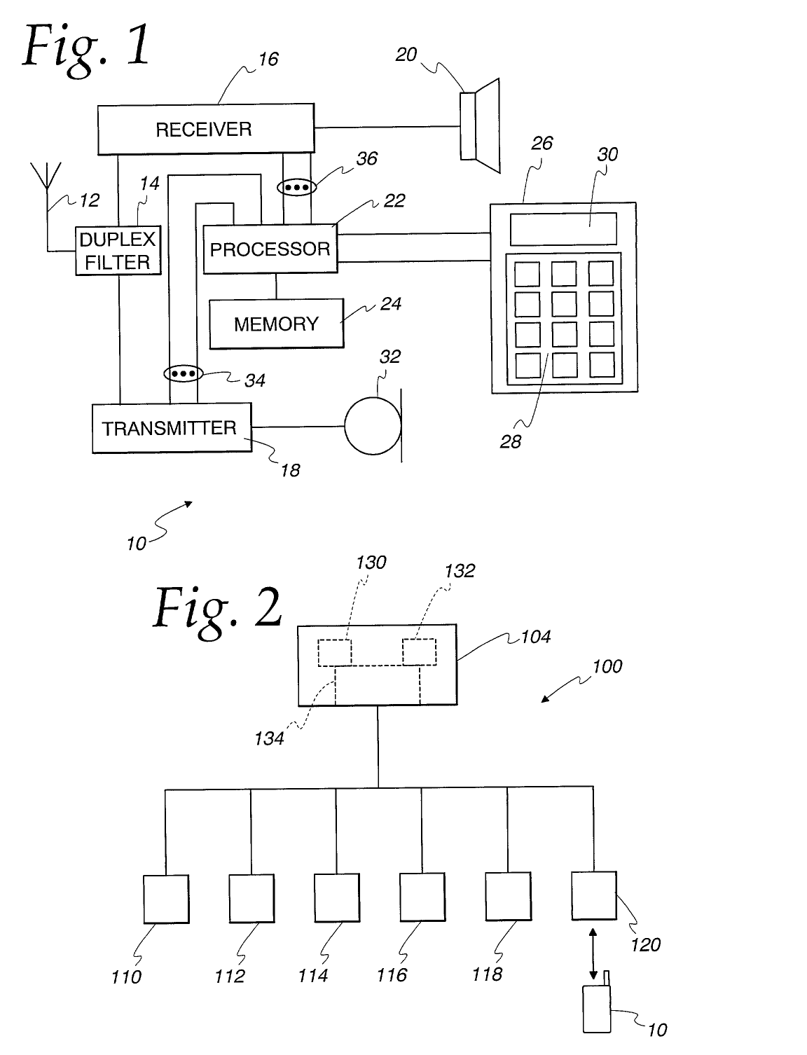

FIG. 1 is a block diagram of a typical mobile terminal 10 which may be used with a wireless system which embodies the present invention.

The mobile terminal 10 includes an antenna 12, a receiver 16, a transmitter, 18, a speaker 20, a processor 22, a memory 24, a user interface 26 and a microphone 32. The antenna 12 is configured to send and receive radio signals between the mobile terminal 10 and a wireless network (not shown in FIG. 1). The antenna 12 is connected to a duplex filter 14 which enables the receiver 16 and the transmitter 18 to receive and broadcast (respectively) on the same antenna 12. The receiver 16 demodulates, demultiplexes and decodes the radio signals into one or more channels. Such channels include a control channel and a traffic channel for speech or data. The speech or data are delivered to the speaker 20 (or other output device, such as a modem or fax connector).

The receiver 16 delivers messages from the control channel to the processor 22. The processor 22 controls and coordinates the functioning of the mobile terminal 10 and is responsive to messages on the control channel using programs and data stored in the memory 24, so that the mobile terminal 10 can operate within the wireless network (not shown). The processor 22 also controls the operation of the mobile terminal 10 and is responsive to input from the user interface 26. The user interface 26 includes a keypad 28 as a user-input device and a display 30 to give the user information. Other devices are frequently included in the user interface 26, such as lights and special purpose buttons. The processor 22 controls the operations of the transmitter 18 and the receiver 16 over control lines 34 and 36, respectively, responsive to control messages and user input.

The microphone 32 (or other data input device) receives speech signal input and converts the input into analog electrical signals. The analog electrical signals are delivered to the transmitter 18. The transmitter 18 converts the analog electrical signals into digital data, encodes the data with error detection and correction information and multiplexes this data with control messages from the processor 22. The transmitter 18 modulates this combined data stream and broadcasts the resultant radio signals to the wireless network through the duplex filter 14 and the antenna 12.

It should be understood, however, that the present invention may be used with still other forms of mobile terminals providing desired wireless communication.

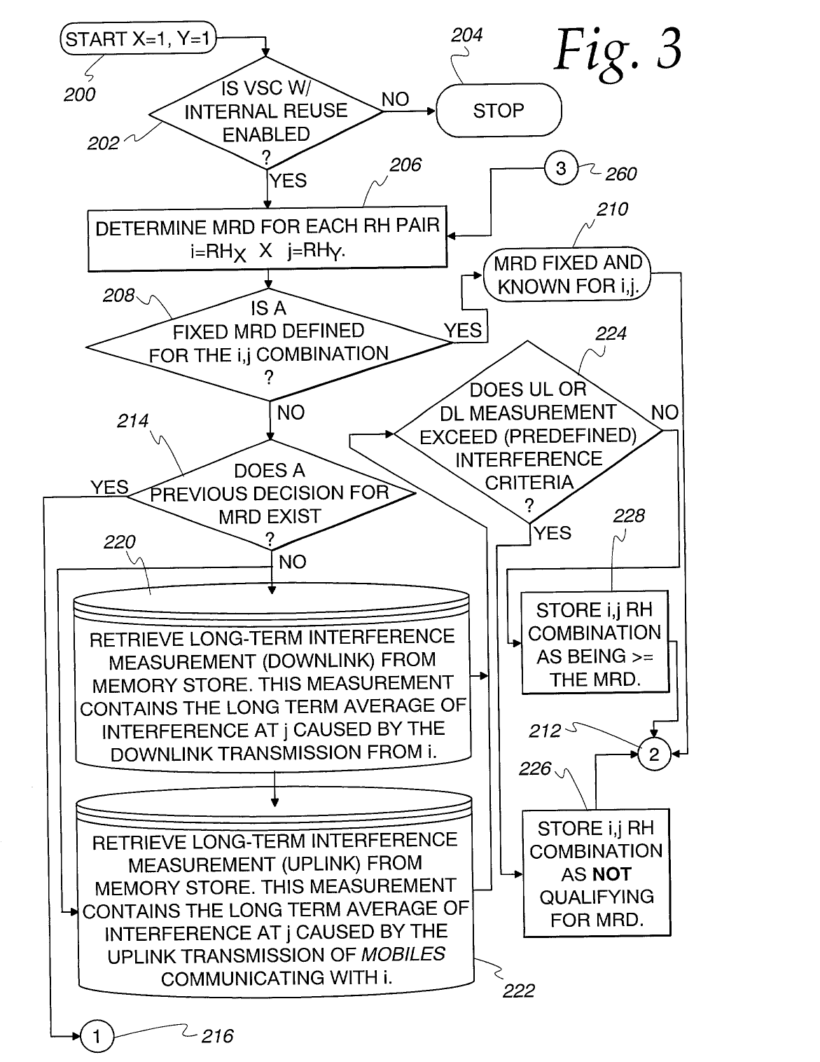

FIG. 2 is a block diagram of a wireless communication network 100 such as a virtual single cell (VSC) with which a mobile terminal 10 may be used. With a VSC network 100, the components described herein are typically in a building.

The network 100 includes a base 104 connected to a plurality of radio heads 110, 112, 114, 116, 118, 120. For ease of reference, the radio heads 110-120 are illustrated in a row, although it should be understood that they would typically spaced to provide complete coverage throughout the three-dimensional space of a building.

The base 104 includes a processor 130, memory 132 and a controller 134. The use of these components is described further below. The controller 134 controls which frequencies the radio heads 110-120 may use (including denying selected radio heads 110-120 the ability to use certain frequencies based on conditions described below) and further handles hand off of a mobile terminal 10 from one radio head 110-120 to another when the mobile terminal moves through different coverage areas in the network 100.

In accordance with the present invention, for each of the radio heads 110-120, it is determined whether unacceptable interference will occur with each of the other radio heads 110-120 if those radio heads simultaneously use the same frequency. For the purposes of discussion here, “Minimum Reuse Distance” is used to describe a value which limits which radio heads 110-120 can share (reuse) a frequency. However, it should be understood that Minimum Reuse Distance is not strictly related to distance between radio heads 110-120, but instead is a reflection of signal attenuation between any two radio heads 110-120.

Such attenuation, or Minimum Reuse Distance, can be determined in several ways.

First, the Minimum Reuse Distance can be determined from the known physical layout of the installation, including the geography of the building and the location of the radio heads 110-120. Path loss/signal attenuation between each radio head 110-120 can be reliably predicted if desired based on such predetermined conditions.

Second, the Minimum Reuse Distance can be determined from measurements. Broadly speaking, using this method, once the network 100 is in place in the building, attenuation of signals could be measured between any two radio heads 110-120 and between an active mobile terminal 10 and a second radio head 110-120 using a specific frequency. The Minimum Reuse Distance for the uplink (i.e., signal from the mobile terminal 10) could be determined by actively measuring a frequency from a potential reuse partner (i.e., another radio head 110-120 which could use the same frequency without giving rise to unacceptable interference) at all times. The Minimum Reuse Distance for the downlink (i.e., signal from the radio head 110-120) could be monitored much less frequently (e.g., only periodically or even only once during set up) since the radio heads 110-120 do not move. For example, if the interference from radio head 110 measured at radio head 120 is within acceptable levels, the network 100 can assume that simultaneous use of the same frequency in those two radio heads 110, 120 is possible. Then, if measurements of an uplink from the mobile terminal 10 to radio head 120 show the interference from that uplink at radio head 110 to be acceptable, then in accordance with the present invention radio heads 110 and 120 will be determined to have the Minimum Reuse Distance (i.e., simultaneous use of a frequency between the two radio heads 110 and 120 will be permitted).

The Minimum Reuse Distance can further be established using long-term averages, so that the relationship between radio heads 110-120 would solidify over time. Minimum Reuse Distance for signals from the mobile terminals 10 would require many more samples since the mobile terminals 10 would move throughout the coverage areas. However, only worst-case readings would need to be stored.

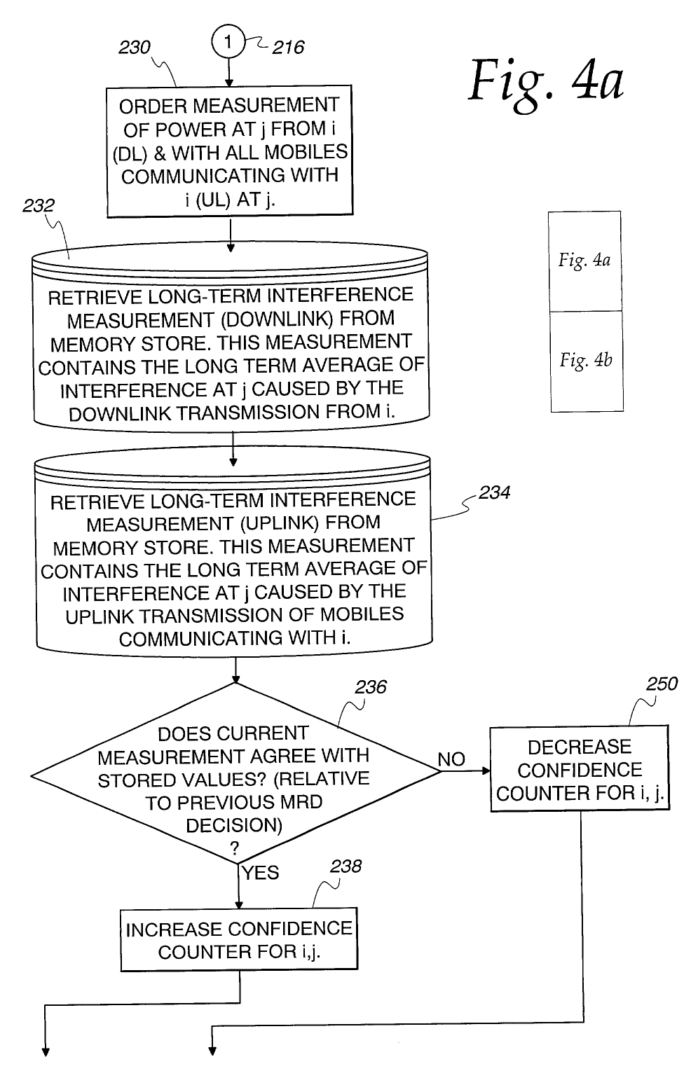

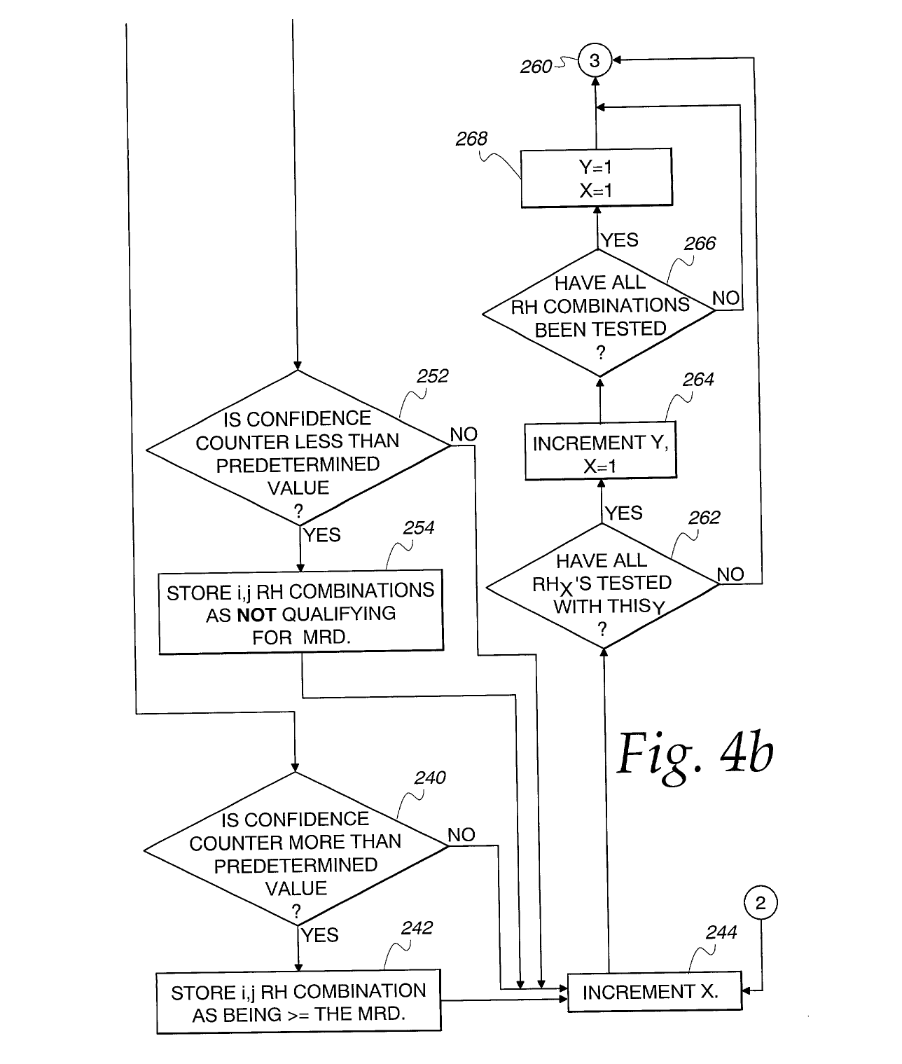

FIGS. 3-4 are a flow chart of the above method of determining Minimum Reuse Distance.

The method starts at box 200, with x and y (which are designations of each radio head 110-120) set as 1. At box 202, it is determined whether or not the VSC network 100 is set to allow internal reuse of frequencies. If it is not, processing stops at box 204. If frequency reuse is allowed, processing proceeds to box 206 where the Minimum Reuse Distance is determined for radio head pair x and y (i.e., it is determined whether frequency reuse can be allowed between i and j).

The method then continues to box 208 where it is determined whether a fixed Minimum Reuse Distance is defined for i and j (i.e., if the Minimum Reuse Distance was determined from the known physical layout of the installation, including the geography of the building and the location of the radio heads 110-120 as previously described). If it has been, processing continues to boxes 210 and 212 to skip various processing steps. If no fixed Minimum Reuse Distance is defined, processing continues to the previously generally described method of determining Minimum Reuse Distance, and specifically continues to box 214 where it is determined if a previous decision for Minimum Reuse Distance exists for radio head pair x and y (i and j). If it has, then processing continues to box 216 where some processing steps are skipped.

If there has not been any previous decision regarding Minimum Reuse Distance for i and j, processing continues to boxes 220 and 222. At 220, long term interference measurements for the downlink (i.e., signal from radio head pair x and y) are retrieved from the memory 132. These stored measurements contain the long term average of interference at j caused by the downlink transmission from i. At 222, similar measurements are retrieved from the memory 132 for the uplink. This retrieved measurement contains the long term average of interference at j caused by the uplink transmission of mobile terminals 10 communicating with i.

These measurements are then compared by the processor 130 at box 224 to determine whether or not either of the uplink or downlink measurements exceed the level which has been established for acceptable interference. If they do exceed acceptable levels, the memory 132 at box 226 stores i and j as being a pair of radio heads which do not qualify for frequency reuse (i.e., they should not be allowed to use the same frequency simultaneously). If the retrieved measurements to not exceed acceptable levels, the memory 132 at box 228 stores i and j as being a pair of radio heads which do qualify for frequency reuse (i.e., they should be allowed to use the same frequency simultaneously). From boxes 226 and 228, processing continues to box 212 to skip various processing steps.

Referring now to FIG. 4, processing from box 216 (where it was determined at box 214 [see FIG. 3] that a previous decision for Minimum Reuse Distance exists for i and j) proceeds to box 230, where a measurement of power at j from i is ordered as well as measurements of power at j with all mobile terminals 10 communicating with i. Processing then proceeds to boxes 232 and 234 where any long term interference measurements in the memory 132 are retrieved much as described in connection with boxes 220 and 222.

The processor 130 then at box 236 compares whether or not the current measurement (from box 230) agrees with the stored values (from boxes 232 and 234) used in the previous reuse decision. If it does, then a confidence counter for the i, j pair is increased at box 238. If the confidence counter is found to be more than a predetermined value (at box 240) (i.e., has a sufficient level of confidence), then the decision regarding frequency reuse between i and j is stored at box 242 in the memory 132, and processing proceeds to box 244 where x is incremented 1.

Referring back to box 236, if the current measurement does not agree with the stored values, processing proceeds to box 250, where the confidence counter for the i, j pair is decreased. If it is determined at box 252 that the confidence relating to the measurement of interference between i and j is not as great as desired (less than a predetermined level), then at box 254 the i, j pair are stored in the memory as not qualifying for frequency reuse, and processing continues to box 244 where x is incremented. If the confidence level is still sufficiently high (as determined at box 252), then the current decision regarding frequency reuse between the i, j pair is not changed, and processing proceeds to box 244.

It should now be seen that processing proceeds to box 244 either from a determination that the Minimum Reuse Distance is fixed for the radio head pair being measured (at box 208), or after an initial reuse determination is made (at boxes 220-228), or after further measurements are made to update the confidence of a previous determination (at boxes 230-242, 250-254). At box 244, x is incremented to proceed at box 260 (returning to box 206) with the same process for another radio head in pair with radio head y. If it is determined at box 262 that all of the other radio heads have been measured relative to radio head y, then y is incremented and x reset to 1 at box 264 and the process is repeated again for all combinations with the next radio head. If it is determined at box 266 that all radio head pairs have been tested, then x and y are reset to 1 and the process can be repeated again.

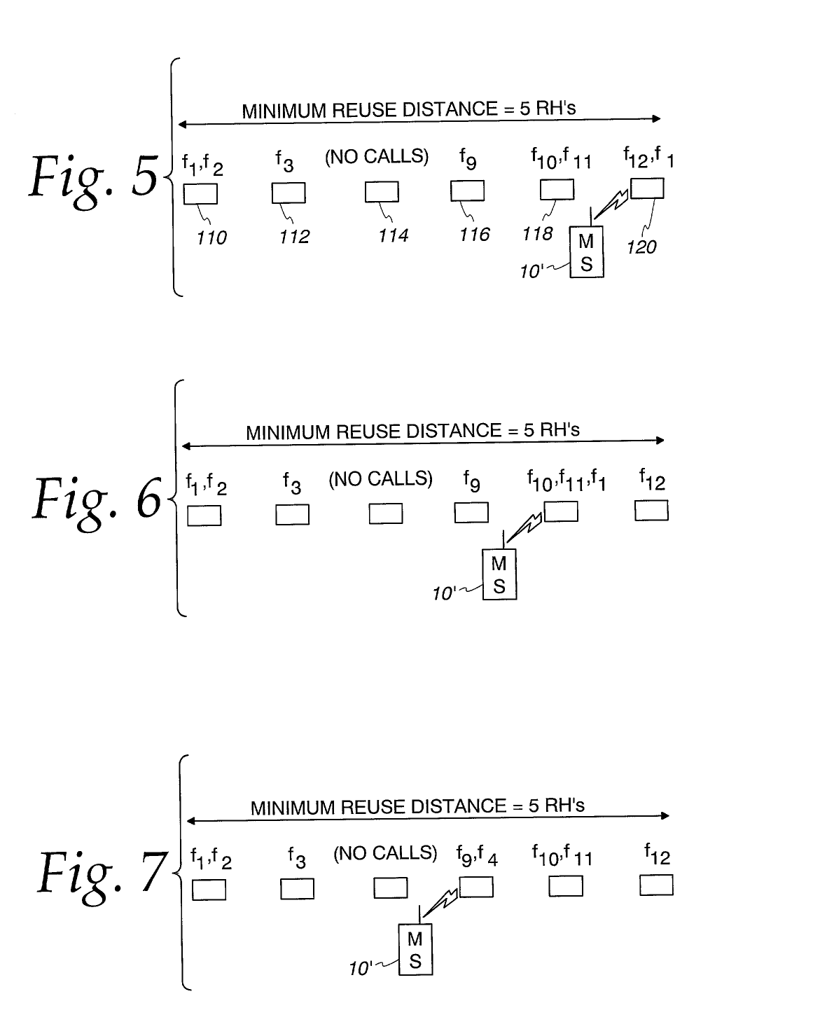

FIGS. 5-7 illustrate operation according to the invention. As illustrated, the Minimum Reuse Distance is assumed to be 5 radio heads, meaning for this illustration that radio head pairs which are 5 apart (i.e., have only 3 between them in the linear illustration) will allow frequency reuse. However, it should be kept in mind, as previously noted, that the Minimum Reuse Distance is not merely a distance measurement as might be reflected in this simple example, but instead is an indication that the interference between the two radio heads is sufficiently low to permit frequency reuse, which determination may be made by individually examining every pair of radio heads.

In the initial condition of FIG. 5, radio head 110 is using two frequencies (f₁ and f₂), radio head 112 is using one frequency (f₃), radio head 114 is using no frequencies (i.e., handling no calls), radio head 116 is using one frequency (f₉), radio head 118 is using two frequencies (f₁₀ and f₁₁), and radio head 120 is using two frequencies (f₁₂ and f₁). Frequency f₁ is being used by radio head 120 to communicate with mobile terminal 10′. Except as otherwise noted, it will be assumed in this example that the frequencies used by the other radio heads will be unchanged over the time period being illustrated here.

As the mobile terminal 10′ moves toward radio head 118 whereby the signal strength with radio head 118 becomes stronger than the signal strength with radio head 120, a decision is made (using, for example, a hysteresis) for the controller 134 to hand off communication with the mobile terminal 10′ from radio head 120 to radio head 118 (see FIG. 6). Since reuse of frequency f₁ by radio head 118 is permitted in these conditions (only radio head 110 is using frequency f₁ and radio heads 110 and 118 have a Minimum Reuse Distance which authorizes simultaneous use of such a frequency by both), a soft hand off (in which the target radio head 118 tunes its transceiver to the frequency of the mobile terminal 10′) will be accomplished by the controller 134 so that radio head 118 will use frequency f₁ in communicating with the mobile terminal 10′.

As the mobile terminal 10′ moves toward the coverage area of radio head 116 whereby the signal strength with radio head 120 becomes stronger than the signal strength with radio head 118, a decision is made (again using, if desired, a hysteresis) for the controller 134 to hand off communication with the mobile terminal 10′ from radio head 118 to radio head 116 (see FIG. 7). Reuse of frequency f₁ by radio head 116 is not permitted in these conditions (radio head 110 is using frequency f₁ and radio heads 110 and 116 have do not have the required Minimum Reuse Distance necessary to authorize simultaneous use of such a frequency by both). Therefore, a hard hand off (in which the mobile terminal 10′ is instructed by the controller 134 to tunes its radio to a different frequency such as frequency f₄ which is not then in use by any radio heads 110-120 which would unacceptably interfere with radio head 116) will be accomplished by the controller 134 so that radio head 116 and mobile terminal will use frequency f₄.

Such use of frequencies as described above will minimize interference between different radio heads while also maximizing the use of the limited frequencies in the available spectrum.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A method of controlling frequency use in a virtual single cell wireless communication network having a plurality of radio heads, comprising:
authorizing all of said radio heads to selectively use all frequencies in a spectrum;
communicating between one radio head and a mobile terminal using one of said frequencies;
determining which of said radio heads will unacceptably interfere with each radio head; denying use of a selected frequency by one radio head whenever said selected frequency is being used by one of said radio heads which were determined to unacceptably interfere with said one radio head; and
determining whether said communication with said mobile terminal should be handed off to another radio head, wherein said handoff is
a soft handoff if said other radio head is not denied use of said one frequency, or
a hard handoff if said other radio head is denied use of said one frequency.

2. The method of claim 1, wherein said other radio head is not denied use of said one frequency based on use of said one frequency by said one radio head which terminates as a result of handing off said mobile terminal.

3. The method of claim 1, further comprising determining which of said radio heads have unacceptable interference with said mobile terminal, and denying use of said one frequency by said other radio head if still another radio head using said one frequency is determined to have unacceptable interference with said mobile terminal.

4. The method of claim 3, wherein said determining which of said radio heads will have unacceptable interference with said mobile terminal comprises continuously measuring said power of said mobile terminal signal at said other radio heads.

5. The method of claim 1, wherein determining which of said radio heads will unacceptably interfere with each radio head comprises determining attenuation between radio heads based on said geography of said network and layout of said radio heads.

6. The method of claim 1, wherein said determining which of said radio heads will unacceptably interfere with each radio head comprises measuring attenuation between said radio heads and determining whether signals with each radio head will unacceptably interfere with other radio heads when subjected to said determined attenuation between said radio heads.

7. The method of claim 6, wherein said measuring attenuation between said radio heads are based on periodic measurements of signals between said radio heads.

8. A method of handing off communication in a virtual single cell wireless communication network having a plurality of radio heads each having a coverage area and adapted to communicate with mobile terminals in their coverage area, comprising:
authorizing all of said radio heads to selectively use all frequencies in a spectrum;
determining which of said radio heads will unacceptably interfere with each radio head; and
handing off a mobile terminal communicating on a first frequency with one radio head when said mobile terminal moves to said coverage area of another radio head by performing a soft handoff if none of said radio heads determined to unacceptably interfere with said other radio head are using said first frequency and performing a hard handoff if any one of said radio heads determined to have unacceptable interference with said other radio head is using said first frequency.

9. The method of claim 8, further comprising denying use of a selected frequency by one radio head whenever said selected frequency is being used by one of said radio heads which were determined to unacceptably interfere with said one radio head.

10. The method of claim 8, further comprising determining which of said radio heads have unacceptable interference with said mobile terminal, and performing a hard hand off if any one of said radio heads determined to have unacceptable interference with said other radio head or said mobile terminal is using said first frequency.

11. The method of claim 10, wherein said determining which of said radio heads will have unacceptable interference with said mobile terminal comprises continuously measuring said power of said mobile terminal signal at said other radio heads and comparing said measured power to a selected acceptable level.

12. A virtual single cell wireless communication network for communicating with mobile terminals, comprising:
a plurality of spaced radio heads each authorized to use all frequencies in a spectrum;
a memory storing, for each of said radio heads, an identification of which of said other radio heads unacceptably interfere with said each radio head;
a controller:
controlling said frequencies used by said plurality of radio heads whereby a frequency being used by one radio head is denied use to radio heads unacceptably interfering with said one radio head, and
controlling handoff of a mobile terminal communicating with a first radio head on a first frequency to change to communicate with a second radio head:
by performing a soft handoff if none of said radio heads stored in said memory as unacceptably interfering with said second radio head are using said first frequency, and
by performing a hard handoff if any one of said radio heads stored in said memory as unacceptably interfering with said second radio head is using said first frequency.

13. The network of claim 12, wherein said memory further stores periodic samples indicating signal attenuation between said radio heads, and further comprising a processor using said samples from said memory to determine which radio heads unacceptably interfere with other radio heads.

14. A virtual single cell wireless communication network, comprising:
a plurality of radio heads each authorized to use every frequency in a spectrum for communicating with a mobile terminal;
a processor identifying unacceptable interference between said radio heads and between said radio heads and said mobile terminal;
a memory storing information on interference between said radio heads and information on interference measured between said radio heads and said mobile terminal; and
a controller
controlling the frequencies used by each radio head,
denying selected radio heads use of a frequency being used by any radio head and/or mobile terminal identified as having unacceptable interference with said selected radio heads, and
controlling handoff of said mobile terminal from a first radio head at a first frequency to a second radio head, said controller
performing a soft handoff if said radio heads identified as having unacceptable interference with said second radio head or said mobile terminal are not using said first frequency, and
performing a hard handoff if any of said radio heads identified as having unacceptable interference with said second radio head or said mobile terminal are using said first frequency.
